(19) United States
(12) Patent Application Publication
(10) Pub. No.: US 2018/0349499 A1
(43) Pub. Date: Dec. 6, 2018

(54) Real-time Counters for Search Results on Online Social Networks

(71) Applicant: FACEBOOK INC., MENLO PARK, CA (US)

(72) Inventors: MANOJ MAHIPAT PAWAR, SAN JOSE, CA (US); YI HUANG, PALO ALTO, CA (US); ABHISHEK KUMAR, UNION CITY, CA (US); ASHUTOSH VISHWAS KULKARNI, KIRKLAND, CA (US)

(21) Appl. No.: 15/611,667

(22) Filed: Jun. 1, 2017

(51) Int. Cl. G06F 17/30

(52) U.S. Cl. CPC G06F 17/30867; G06F 17/3053; G06F 17/30554

(57) ABSTRACT

In one embodiment, a method includes by one or more computing machines: receiving a search query from a user, generating a normalized query based on the search query, identifying multiple objects matching the search query, and calculating an engagement score for each object. The engagement score is based on real-time counters and batch counters. Each counter includes: a key listing the object, normalized query, and one of multiple types of user interactions; and a value indicating a number of user interactions with the object performed in response to search queries normalizing to the normalized query. The value for real-time and batch counters indicates user interactions during first and second threshold windows of time, respectively. The method continues with sending, to the user, a search-results interface including results corresponding to the identified objects above a threshold engagement score, and updating the real-time counters based on user interactions with the search results.

### TECHNICAL FIELD

This disclosure generally relates to social graphs and performing searches for objects within a social-networking environment.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

Social-graph analysis views social relationships in terms of network theory consisting of nodes and edges. Nodes represent the individual actors within the networks, and edges represent the relationships between the actors. The resulting graph-based structures are often very complex. There can be many types of nodes and many types of edges for connecting nodes. In its simplest form, a social graph is a map of all of the relevant edges between all the nodes being studied.

### SUMMARY OF PARTICULAR EMBODIMENTS

In particular embodiments, a social-networking system may provide search results to a querying user based on user interactions with objects on an online social network. The social-networking system may receive a search query and use a normalization component to generate one or more normalized queries based on the search query. The social-networking system may maintain a plurality of real-time counters and batch counters of user interactions with objects on the online social network. Each counter may store a number of the particular type of user interaction the social-networking system has recorded. The social-networking system may identify objects on the online social network that match the received search query. The social-networking system may calculate an engagement score for each of the identified objects. The engagement score may be a weighted combination of values from one or more real-time counters and one or more batch counters associated with the identified object. By calculating an engagement score based on real-time and batch counters, the social-networking system may provide search results to users incorporating items with a comparatively high level of recent user interaction and items with a comparatively high level of user interactions historically. The social-networking system may provide search results representing trends and relationships between identified objects, search queries, and user interactions by calculating an engagement score based on counters with a plurality of keys. Using a normalized query allows the social-networking system to identify related search queries and provide search results based on related search queries. The social-networking system may present to the user a search-results interface comprising a plurality of search results corresponding to a plurality of identified objects, respectively. The social-networking system may record user interactions with the identified objects corresponding to the search results and update one or more real-time counters. The social-networking system may periodically update one or more batch counters based on one or more real-time counters. The updated real-time counters and batch counter may be used to provide search results for subsequent search queries.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment associated with a social-networking system.

FIG. 2 illustrates an example social graph.

FIG. 3 illustrates an example partitioning for storing objects of a social-networking system.

FIG. 4 illustrates an example configuration of a social-networking system supporting real-time counters and batch counters.

FIG. 5 illustrates an example method 500 for providing search results to a user based on real-time counters or batch counters.

FIG. 6 illustrates an example computer system.

### DESCRIPTION OF EXAMPLE EMBODIMENTS

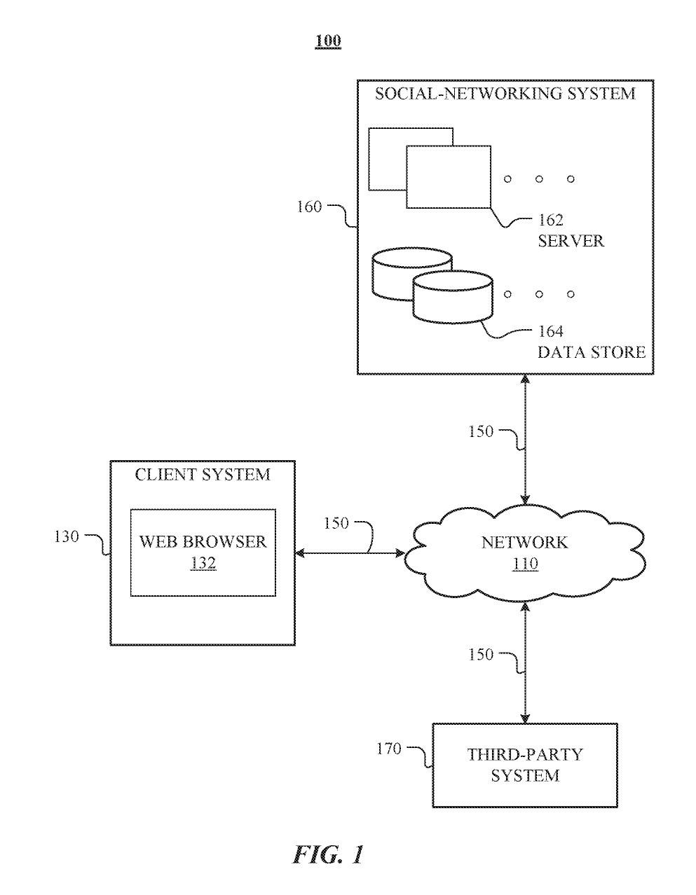

FIG. 1 illustrates an example network environment 100 associated with a social-networking system. Network environment 100 includes a client system 130, a social-networking system 160, and a third-party system 170 connected to each other by a network 110. Although FIG. 1 illustrates a particular arrangement of a client system 130, a social-networking system 160, a third-party system 170, and a network 110, this disclosure contemplates any suitable arrangement of a client system 130, a social-networking system 160, a third-party system 170, and a network 110. As an example and not by way of limitation, two or more of a client system 130, a social-networking system 160, and a third-party system 170 may be connected to each other directly, bypassing a network 110. As another example, two or more of a client system 130, a social-networking system 160, and a third-party system 170 may be physically or logically co-located with each other in whole or in part. Moreover, although FIG. 1 illustrates a particular number of client systems 130, social-networking systems 160, third-party systems 170, and networks 110, this disclosure contemplates any suitable number of client systems 130, social-networking systems 160, third-party systems 170, and networks 110. As an example and not by way of limitation, network environment 100 may include multiple client systems 130, social-networking systems 160, third-party systems 170, and networks 110.

This disclosure contemplates any suitable network 110. As an example and not by way of limitation, one or more portions of a network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 110 may include one or more networks 110.

Links 150 may connect a client system 130, a social-networking system 160, and a third-party system 170 to a communication network 110 or to each other. This disclosure contemplates any suitable links 150. In particular embodiments, one or more links 150 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout a network environment 100. One or more first links 150 may differ in one or more respects from one or more second links 150.

In particular embodiments, a client system 130 may be an electronic device including hardware, software, or embedded logic components or a combination of two or more such components and capable of carrying out the appropriate functionalities implemented or supported by a client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 130. A client system 130 may enable a network user at a client system 130 to access a network 110. A client system 130 may enable its user to communicate with other users at other client systems 130.

In particular embodiments, a client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at a client system 130 may enter a Uniform Resource Locator (URL) or other address directing a web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to a client system 130 one or more Hyper Text Markup Language (HTML) files responsive to the HTTP request. The client system 130 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web interface encompasses one or more corresponding source files (which a browser may use to render the web interface) and vice versa, where appropriate.

In particular embodiments, the social-networking system 160 may be a network-addressable computing system that can host an online social network. The social-networking system 160 may generate, store, receive, and send social-networking data, such as, for example, user-profile data, concept-profile data, social-graph information, or other suitable data related to the online social network. The social-networking system 160 may be accessed by the other components of network environment 100 either directly or via a network 110. As an example and not by way of limitation, a client system 130 may access the social-networking system 160 using a web browser 132, or a native application associated with the social-networking system 160 (e.g., a mobile social-networking application, a messaging application, another suitable application, or any combination thereof) either directly or via a network 110. In particular embodiments, the social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, the social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, or a third-party system 170 to manage, retrieve, modify, add, or delete, the information stored in data store 164.

In particular embodiments, the social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. The social-networking system 160 may provide users of the online social network the ability to communicate and interact with other users. In particular embodiments, users may join the online social network via the social-networking system 160 and then add connections (e.g., relationships) to a number of other users of the social-networking system 160 whom they want to be connected to. Herein, the term “friend” may refer to any other user of the social-networking system 160 with whom a user has formed a connection, association, or relationship via the social-networking system 160.

In particular embodiments, the social-networking system 160 may provide users with the ability to take actions on various types of items or objects, supported by the social-networking system 160. As an example and not by way of limitation, the items and objects may include groups or social networks to which users of the social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 160 or by an external system of a third-party system 170, which is separate from the social-networking system 160 and coupled to the social-networking system 160 via a network 110.

In particular embodiments, the social-networking system 160 may be capable of linking a variety of entities. As an example and not by way of limitation, the social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating the social-networking system 160. In particular embodiments, however, the social-networking system 160 and third-party systems 170 may operate in conjunction with each other to provide social-networking services to users of the social-networking system 160 or third-party systems 170. In this sense, the social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, the social-networking system 160 also includes user-generated content objects, which may enhance a user's interactions with the social-networking system 160. User-generated content may include anything a user can add, upload, send, or “post” to the social-networking system 160. As an example and not by way of limitation, a user communicates posts to the social-networking system 160 from a client system 130. Posts may include data such as status updates or other textual data, location information, photos, videos, links, music or other similar data or media. Content may also be added to the social-networking system 160 by a third-party through a “communication channel,” such as a newsfeed or stream.

In particular embodiments, the social-networking system 160 may include a variety of servers, sub-systems, programs, modules, logs, and data stores. In particular embodiments, the social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 160 may also include suitable components such as network interfaces, security mechanisms, load balancers, failover servers, management-and-network-operations consoles, other suitable components, or any suitable combination thereof. In particular embodiments, the social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 160 to one or more client systems 130 or one or more third-party systems 170 via a network 110. The web server may include a mail server or other messaging functionality for receiving and routing messages between the social-networking system 160 and one or more client systems 130. An API-request server may allow a third-party system 170 to access information from the social-networking system 160 by calling one or more APIs. An action logger may be used to receive communications from a web server about a user's actions on or off the social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from a client system 130 responsive to a request received from a client system 130. Authorization servers may be used to enforce one or more privacy settings of the users of the social-networking system 160. A privacy setting of a user determines how particular information associated with a user can be shared. The authorization server may allow users to opt in to or opt out of having their actions logged by the social-networking system 160 or shared with other systems (e.g., a third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

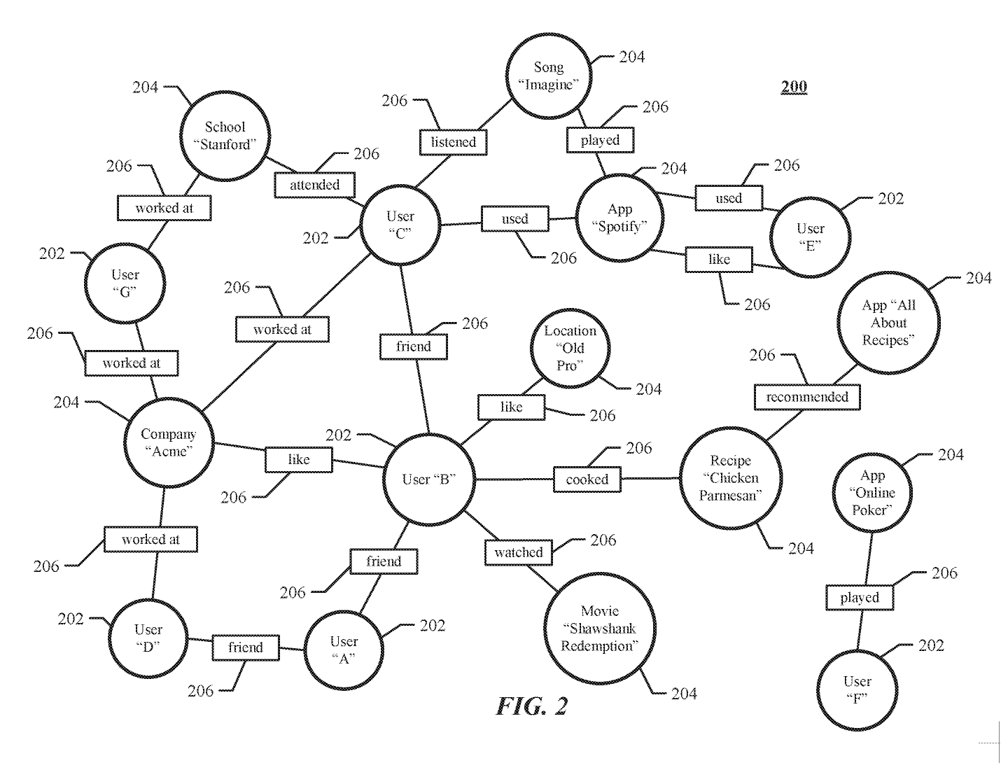

FIG. 2 illustrates an example social graph 200. In particular embodiments, the social-networking system 160 may store one or more social graphs 200 in one or more data stores. In particular embodiments, the social graph 200 may include multiple nodes—which may include multiple user nodes 202 or multiple concept nodes 204—and multiple edges 206 connecting the nodes. The example social graph 200 illustrated in FIG. 2 is shown, for didactic purposes, in a two-dimensional visual map representation. In particular embodiments, a social-networking system 160, a client system 130, or a third-party system 170 may access the social graph 200 and related social-graph information for suitable applications. The nodes and edges of the social graph 200 may be stored as data objects, for example, in a data store (such as a social-graph database). Such a data store may include one or more searchable or queryable indexes of nodes or edges of the social graph 200.

In particular embodiments, a user node 202 may correspond to a user of the social-networking system 160. As an example and not by way of limitation, a user may be an individual (human user), an entity (e.g., an enterprise, business, or third-party application), or a group (e.g., of individuals or entities) that interacts or communicates with or over the social-networking system 160. In particular embodiments, when a user registers for an account with the social-networking system 160, the social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with the social-networking system 160. In particular embodiments, a user node 202 may be associated with information provided by a user or information gathered by various systems, including the social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more web interfaces.

In particular embodiments, a concept node 204 may correspond to a concept. As an example and not by way of limitation, a concept may correspond to a place (such as, for example, a movie theater, restaurant, landmark, or city); a website (such as, for example, a website associated with the social-networking system 160 or a third-party website associated with a web-application server); an entity (such as, for example, a person, business, group, sports team, or celebrity); a resource (such as, for example, an audio file, video file, digital photo, text file, structured document, or application) which may be located within the social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including the social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more web interfaces.

In particular embodiments, a node in the social graph 200 may represent or be represented by a web interface (which may be referred to as a “profile interface”). Profile interfaces may be hosted by or accessible to the social-networking system 160. Profile interfaces may also be hosted on third-party websites associated with a third-party system 170. As an example and not by way of limitation, a profile interface corresponding to a particular external web interface may be the particular external web interface and the profile interface may correspond to a particular concept node 204. Profile interfaces may be viewable by all or a selected subset of other users. As an example and not by way of limitation, a user node 202 may have a corresponding user-profile interface in which the corresponding user may add content, make declarations, or otherwise express himself or herself. As another example and not by way of limitation, a concept node 204 may have a corresponding concept-profile interface in which one or more users may add content, make declarations, or express themselves, particularly in relation to the concept corresponding to concept node 204.

In particular embodiments, a concept node 204 may represent a third-party web interface or resource hosted by a third-party system 170. The third-party web interface or resource may include, among other elements, content, a selectable or other icon, or other inter-actable object (which may be implemented, for example, in JavaScript, AJAX, or PHP codes) representing an action or activity. As an example and not by way of limitation, a third-party web interface may include a selectable icon such as “like,” “check-in,” “eat,” “recommend,” or another suitable action or activity. A user viewing the third-party web interface may perform an action by selecting one of the icons (e.g., “check-in”), causing a client system 130 to send to the social-networking system 160 a message indicating the user's action. In response to the message, the social-networking system 160 may create an edge (e.g., a check-in-type edge) between a user node 202 corresponding to the user and a concept node 204 corresponding to the third-party web interface or resource and store edge 206 in one or more data stores.

In particular embodiments, a pair of nodes in the social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, the social-networking system 160 may send a “friend request” to the second user. If the second user confirms the “friend request,” the social-networking system 160 may create an edge 206 connecting the first user's user node 202 to the second user's user node 202 in the social graph 200 and store edge 206 as social-graph information in one or more of data stores 164. In the example of FIG. 2, the social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in the social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to an edge type or subtype. A concept-profile interface corresponding to a concept node 204 may include, for example, a selectable “check in” icon (such as, for example, a clickable “check in” icon) or a selectable “add to favorites” icon. Similarly, after a user clicks these icons, the social-networking system 160 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, the social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, the social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, the social-networking system 160 may create an edge 206 between a user node 202 and a concept node 204 in the social graph 200. As an example and not by way of limitation, a user viewing a concept-profile interface (such as, for example, by using a web browser or a special-purpose application hosted by the user's client system 130) may indicate that he or she likes the concept represented by the concept node 204 by clicking or selecting a “Like” icon, which may cause the user's client system 130 to send to the social-networking system 160 a message indicating the user's liking of the concept associated with the concept-profile interface. In response to the message, the social-networking system 160 may create an edge 206 between user node 202 associated with the user and concept node 204, as illustrated by “like” edge 206 between the user and concept node 204. In particular embodiments, the social-networking system 160 may store an edge 206 in one or more data stores. In particular embodiments, an edge 206 may be automatically formed by the social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

In particular embodiments, the social-networking system 160 may receive, from a client system of a user of an online social network, a query inputted by the user. The user may submit the query to the social-networking system 160 by, for example, selecting a query input or inputting text into query field. A user of an online social network may search for information relating to a specific subject matter (e.g., users, concepts, external content or resource) by providing a short phrase describing the subject matter, often referred to as a “search query,” to a search engine. The query may be an unstructured text query and may comprise one or more text strings (which may include one or more n-grams). In general, a user may input any character string into a query field to search for content on the social-networking system 160 that matches the text query. The social-networking system 160 may then search a data store 164 (or, in particular, a social-graph database) to identify content matching the query. The search engine may conduct a search based on the query phrase using various search algorithms and generate search results that identify resources or content (e.g., user-profile interfaces, content-profile interfaces, or external resources) that are most likely to be related to the search query. To conduct a search, a user may input or send a search query to the search engine. In response, the search engine may identify one or more resources that are likely to be related to the search query, each of which may individually be referred to as a “search result,” or collectively be referred to as the “search results” corresponding to the search query. The identified content may include, for example, social-graph elements (i.e., user nodes 202, concept nodes 204, edges 206), profile interfaces, external web interfaces, or any combination thereof. The social-networking system 160 may then generate a search-results interface with search results corresponding to the identified content and send the search-results interface to the user. The search results may be presented to the user, often in the form of a list of links on the search-results interface, each link being associated with a different interface that contains some of the identified resources or content. In particular embodiments, each link in the search results may be in the form of a Uniform Resource Locator (URL) that specifies where the corresponding interface is located and the mechanism for retrieving it. The social-networking system 160 may then send the search-results interface to the web browser 132 on the user's client system 130. The user may then click on the URL links or otherwise select the content from the search-results interface to access the content from the social-networking system 160 or from an external system (such as, for example, a third-party system 170), as appropriate. The resources may be ranked and presented to the user according to their relative degrees of relevance to the search query. The search results may also be ranked and presented to the user according to their relative degree of relevance to the user. In other words, the search results may be personalized for the querying user based on, for example, social-graph information, user information, search or browsing history of the user, or other suitable information related to the user. In particular embodiments, ranking of the resources may be determined by a ranking algorithm implemented by the search engine. As an example and not by way of limitation, resources that are more relevant to the search query or to the user may be ranked higher than the resources that are less relevant to the search query or the user. In particular embodiments, the search engine may limit its search to resources and content on the online social network. However, in particular embodiments, the search engine may also search for resources or contents on other sources, such as a third-party system 170, the internet or World Wide Web, or other suitable sources. Although this disclosure describes querying the social-networking system 160 in a particular manner, this disclosure contemplates querying the social-networking system 160 in any suitable manner.

In particular embodiments, one or more client-side and/or backend (server-side) processes may implement and utilize a “typeahead” feature that may automatically attempt to match social-graph elements (e.g., user nodes 202, concept nodes 204, or edges 206) to information currently being entered by a user in an input form rendered in conjunction with a requested interface (such as, for example, a user-profile interface, a concept-profile interface, a search-results interface, a user interface/view state of a native application associated with the online social network, or another suitable interface of the online social network), which may be hosted by or accessible in the social-networking system 160. In particular embodiments, as a user is entering text to make a declaration, the typeahead feature may attempt to match the string of textual characters being entered in the declaration to strings of characters (e.g., names, descriptions) corresponding to users, concepts, or edges and their corresponding elements in the social graph 200. In particular embodiments, when a match is found, the typeahead feature may automatically populate the form with a reference to the social-graph element (such as, for example, the node name/type, node ID, edge name/type, edge ID, or another suitable reference or identifier) of the existing social-graph element. In particular embodiments, as the user enters characters into a form box, the typeahead process may read the string of entered textual characters. As each keystroke is made, the frontend-typeahead process may send the entered character string as a request (or call) to the backend-typeahead process executing within the social-networking system 160. In particular embodiments, the typeahead process may use one or more matching algorithms to attempt to identify matching social-graph elements. In particular embodiments, when a match or matches are found, the typeahead process may send a response to the user's client system 130 that may include, for example, the names (name strings) or descriptions of the matching social-graph elements as well as, potentially, other metadata associated with the matching social-graph elements. As an example and not by way of limitation, if a user enters the characters “pok” into a query field, the typeahead process may display a drop-down menu that displays names of matching existing profile interfaces and respective user nodes 202 or concept nodes 204, such as a profile interface named or devoted to “poker” or “pokemon,” which the user can then click on or otherwise select thereby confirming the desire to declare the matched user or concept name corresponding to the selected node.

More information on typeahead processes may be found in U.S. patent application Ser. No. 12/763,162, filed 19 Apr. 2010, and U.S. patent application Ser. No. 13/556,072, filed 23 Jul. 2012, which are incorporated by reference.

In particular embodiments, the typeahead processes described herein may be applied to search queries entered by a user. As an example and not by way of limitation, as a user enters text characters into a query field, a typeahead process may attempt to identify one or more user nodes 202, concept nodes 204, or edges 206 that match the string of characters entered into the query field as the user is entering the characters. As the typeahead process receives requests or calls including a string or n-gram from the text query, the typeahead process may perform or cause to be performed a search to identify existing social-graph elements (i.e., user nodes 202, concept nodes 204, edges 206) having respective names, types, categories, or other identifiers matching the entered text. The typeahead process may use one or more matching algorithms to attempt to identify matching nodes or edges. When a match or matches are found, the typeahead process may send a response to the user's client system 130 that may include, for example, the names (name strings) of the matching nodes as well as, potentially, other metadata associated with the matching nodes. The typeahead process may then display a drop-down menu that displays names of matching existing profile interfaces and respective user nodes 202 or concept nodes 204, and displays names of matching edges 206 that may connect to the matching user nodes 202 or concept nodes 204, which the user can then click on or otherwise select thereby confirming the desire to search for the matched user or concept name corresponding to the selected node, or to search for users or concepts connected to the matched users or concepts by the matching edges. Alternatively, the typeahead process may simply auto-populate the form with the name or other identifier of the top-ranked match rather than display a drop-down menu. The user may then confirm the auto-populated declaration simply by keying “enter” on a keyboard or by clicking on the auto-populated declaration. Upon user confirmation of the matching nodes and edges, the typeahead process may send a request that informs the social-networking system 160 of the user's confirmation of a query containing the matching social-graph elements. In response to the request sent, the social-networking system 160 may automatically (or alternately based on an instruction in the request) call or otherwise search a social-graph database for the matching social-graph elements, or for social-graph elements connected to the matching social-graph elements as appropriate. Although this disclosure describes applying the typeahead processes to search queries in a particular manner, this disclosure contemplates applying the typeahead processes to search queries in any suitable manner.

In connection with search queries and search results, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, and U.S. patent application Ser. No. 12/978,265, filed 23 Dec. 2010, which are incorporated by reference.

In particular embodiments, in response to a text query received from a first user (i.e., the querying user), the social-networking system 160 may parse the text query and identify portions of the text query that correspond to particular social-graph elements. However, in some cases a query may include one or more terms that are ambiguous, where an ambiguous term is a term that may possibly correspond to multiple social-graph elements. To parse the ambiguous term, the social-networking system 160 may access a social graph 200 and then parse the text query to identify the social-graph elements that corresponded to ambiguous n-grams from the text query. The social-networking system 160 may then generate a set of structured queries, where each structured query corresponds to one of the possible matching social-graph elements. These structured queries may be based on strings generated by a grammar model, such that they are rendered in a natural-language syntax with references to the relevant social-graph elements. As an example and not by way of limitation, in response to the text query, “show me friends of my girlfriend,” the social-networking system 160 may generate a structured query “Friends of Stephanie,” where “Friends” and “Stephanie” in the structured query are references corresponding to particular social-graph elements. The reference to “Stephanie” would correspond to a particular user node 202 (where the social-networking system 160 has parsed the n-gram “my girlfriend” to correspond with a user node 202 for the user “Stephanie”), while the reference to “Friends” would correspond to friend-type edges 206 connecting that user node 202 to other user nodes 202 (i.e., edges 206 connecting to “Stephanie's” first-degree friends). When executing this structured query, the social-networking system 160 may identify one or more user nodes 202 connected by friend-type edges 206 to the user node 202 corresponding to “Stephanie”. As another example and not by way of limitation, in response to the text query, “friends who work at facebook,” the social-networking system 160 may generate a structured query “My friends who work at Facebook,” where “my friends,” “work at,” and “Facebook” in the structured query are references corresponding to particular social-graph elements as described previously (i.e., a friend-type edge 206, a work-at-type edge 206, and concept node 204 corresponding to the company “Facebook”). By providing suggested structured queries in response to a user's text query, the social-networking system 160 may provide a powerful way for users of the online social network to search for elements represented in the social graph 200 based on their social-graph attributes and their relation to various social-graph elements. Structured queries may allow a querying user to search for content that is connected to particular users or concepts in the social graph 200 by particular edge-types. The structured queries may be sent to the first user and displayed in a drop-down menu (via, for example, a client-side typeahead process), where the first user can then select an appropriate query to search for the desired content. Some of the advantages of using the structured queries described herein include finding users of the online social network based upon limited information, bringing together virtual indexes of content from the online social network based on the relation of that content to various social-graph elements, or finding content related to you and/or your friends. Although this disclosure describes generating particular structured queries in a particular manner, this disclosure contemplates generating any suitable structured queries in any suitable manner.

More information on element detection and parsing queries may be found in U.S. patent application Ser. No. 13/556,072, filed 23 Jul. 2012, U.S. patent application Ser. No. 13/731,866, filed 31 Dec. 2012, and U.S. patent application Ser. No. 13/732,101, filed 31 Dec. 2012, each of which is incorporated by reference. More information on structured search queries and grammar models may be found in U.S. patent application Ser. No. 13/556,072, filed 23 Jul. 2012, U.S. patent application Ser. No. 13/674,695, filed 12 Nov. 2012, and U.S. patent application Ser. No. 13/731,866, filed 31 Dec. 2012, each of which is incorporated by reference.

In particular embodiments, the social-networking system 160 may provide customized keyword completion suggestions to a querying user as the user is inputting a text string into a query field. Keyword completion suggestions may be provided to the user in a non-structured format. In order to generate a keyword completion suggestion, the social-networking system 160 may access multiple sources within the social-networking system 160 to generate keyword completion suggestions, score the keyword completion suggestions from the multiple sources, and then return the keyword completion suggestions to the user. As an example and not by way of limitation, if a user types the query “friends stan,” then the social-networking system 160 may suggest, for example, “friends stanford,” “friends stanford university,” “friends stanley,” “friends stanley cooper,” “friends stanley kubrick,” “friends stanley cup,” and “friends stanlonski.” In this example, the social-networking system 160 is suggesting the keywords which are modifications of the ambiguous n-gram “stan,” where the suggestions may be generated from a variety of keyword generators. The social-networking system 160 may have selected the keyword completion suggestions because the user is connected in some way to the suggestions. As an example and not by way of limitation, the querying user may be connected within the social graph 200 to the concept node 204 corresponding to Stanford University, for example by like- or attended-type edges 206. The querying user may also have a friend named Stanley Cooper. Although this disclosure describes generating keyword completion suggestions in a particular manner, this disclosure contemplates generating keyword completion suggestions in any suitable manner.

More information on keyword queries may be found in U.S. patent application Ser. No. 14/244,748, filed 3 Apr. 2014, U.S. patent application Ser. No. 14/470,607, filed 27 Aug. 2014, and U.S. patent application Ser. No. 14/561,418, filed 5 Dec. 2014, each of which is incorporated by reference.

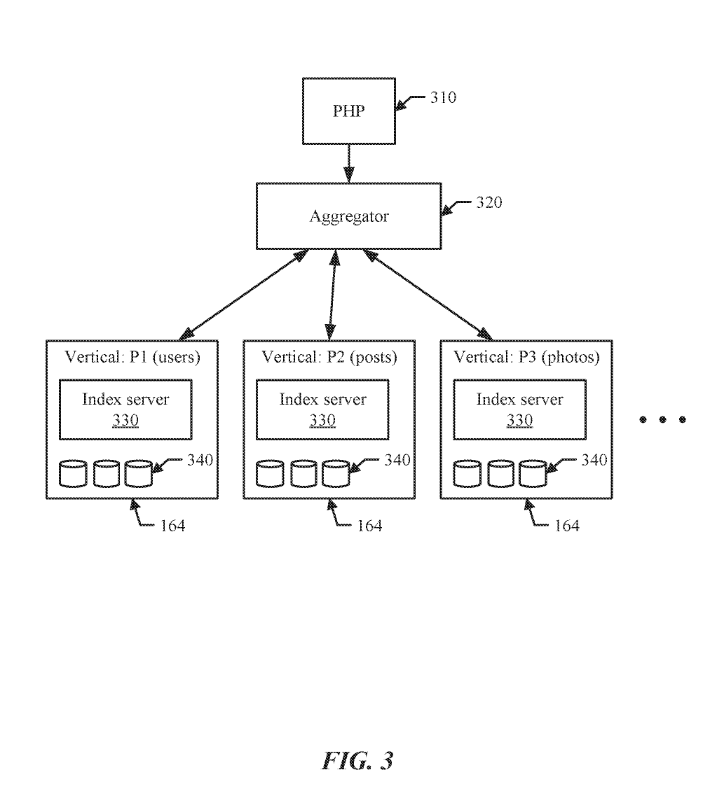

FIG. 3 illustrates an example partitioning for storing objects of a social-networking system 160. A plurality of data stores 164 (which may also be called “verticals”) may store objects of social-networking system 160. The amount of data (e.g., data for a social graph 200) stored in the data stores may be very large. As an example and not by way of limitation, a social graph used by Facebook, Inc. of Menlo Park, Calif. can have a number of nodes in the order of 10⁸, and a number of edges in the order of 10¹⁰. Typically, a large collection of data such as a large database may be divided into a number of partitions. As the index for each partition of a database is smaller than the index for the overall database, the partitioning may improve performance in accessing the database. As the partitions may be distributed over a large number of servers, the partitioning may also improve performance and reliability in accessing the database. Ordinarily, a database may be partitioned by storing rows (or columns) of the database separately. In particular embodiments, a database maybe partitioned based on object-types. Data objects may be stored in a plurality of partitions, each partition holding data objects of a single object-type. In particular embodiments, social-networking system 160 may retrieve search results in response to a search query by submitting the search query to a particular partition storing objects of the same object-type as the search query's expected results. Although this disclosure describes storing objects in a particular manner, this disclosure contemplates storing objects in any suitable manner.

In particular embodiments, each object may correspond to a particular node of a social graph 200. An edge 206 connecting the particular node and another node may indicate a relationship between objects corresponding to these nodes. In addition to storing objects, a particular data store may also store social-graph information relating to the object. Alternatively, social-graph information about particular objects may be stored in a different data store from the objects. Social-networking system 160 may update the search index of the data store based on newly received objects, and relationships associated with the received objects.

In particular embodiments, each data store 164 may be configured to store objects of a particular one of a plurality of object-types in respective data storage devices 340. An object-type may be, for example, a user, a photo, a post, a comment, a message, an event listing, a web interface, an application, a location, a user-profile interface, a concept-profile interface, a user group, an audio file, a video, an offer/coupon, or another suitable type of object. Although this disclosure describes particular types of objects, this disclosure contemplates any suitable types of objects. As an example and not by way of limitation, a user vertical P1 illustrated in FIG. 3 may store user objects. Each user object stored in the user vertical P1 may comprise an identifier (e.g., a character string), a user name, and a profile picture for a user of the online social network. Social-networking system 160 may also store in the user vertical P1 information associated with a user object such as language, location, education, contact information, interests, relationship status, a list of friends/contacts, a list of family members, privacy settings, and so on. As an example and not by way of limitation, a post vertical P2 illustrated in FIG. 3 may store post objects. Each post object stored in the post vertical P2 may comprise an identifier, a text string for a post posted to social-networking system 160. Social-networking system 160 may also store in the post vertical P2 information associated with a post object such as a time stamp, an author, privacy settings, users who like the post, a count of likes, comments, a count of comments, location, and so on. As an example and not by way of limitation, a photo vertical P3 may store photo objects (or objects of other media types such as video or audio). Each photo object stored in the photo vertical P3 may comprise an identifier and a photo. Social-networking system 160 may also store in the photo vertical P3 information associated with a photo object such as a time stamp, an author, privacy settings, users who are tagged in the photo, users who like the photo, comments, and so on. In particular embodiments, each data store may also be configured to store information associated with each stored object in data storage devices 340.

In particular embodiments, objects stored in each vertical 164 may be indexed by one or more search indices. The search indices may be hosted by respective index server 330 comprising one or more computing devices (e.g., servers). The index server 330 may update the search indices based on data (e.g., a photo and information associated with a photo) submitted to social-networking system 160 by users or other processes of social-networking system 160 (or a third-party system). The index server 330 may also update the search indices periodically (e.g., every 24 hours). The index server 330 may receive a query comprising a search term, and access and retrieve search results from one or more search indices corresponding to the search term. In some embodiments, a vertical corresponding to a particular object-type may comprise a plurality of physical or logical partitions, each comprising respective search indices.

In particular embodiments, social-networking system 160 may receive a search query from a PHP (Hypertext Preprocessor) process 310. The PHP process 310 may comprise one or more computing processes hosted by one or more servers 162 of social-networking system 160. The search query may be a text string or a search query submitted to the PHP process by a user or another process of social-networking system 160 (or third-party system 170). In particular embodiments, an aggregator 320 may be configured to receive the search query from PHP process 310 and distribute the search query to each vertical. The aggregator may comprise one or more computing processes (or programs) hosted by one or more computing devices (e.g. servers) of the social-networking system 160. Particular embodiments may maintain the plurality of verticals 164 as illustrated in FIG. 3. Each of the verticals 164 may be configured to store a single type of object indexed by a search index as described earlier. In particular embodiments, the aggregator 320 may receive a search request. For example, the aggregator 320 may receive a search request from a PHP (Hypertext Preprocessor) process 210 illustrated in FIG. 2. In particular embodiments, the search request may comprise a text string. The search request may be a structured or substantially unstructured text string submitted by a user via a PHP process. The search request may also be structured or a substantially unstructured text string received from another process of the social-networking system. In particular embodiments, the aggregator 320 may determine one or more search queries based on the received search request. In particular embodiments, each of the search queries may have a single object type for its expected results (i.e., a single result-type). In particular embodiments, the aggregator 320 may, for each of the search queries, access and retrieve search query results from at least one of the verticals 164, wherein the at least one vertical 164 is configured to store objects of the object type of the search query (i.e., the result-type of the search query). In particular embodiments, the aggregator 320 may aggregate search query results of the respective search queries. For example, the aggregator 320 may submit a search query to a particular vertical and access index server 330 of the vertical, causing index server 330 to return results for the search query.

More information on indexes and search queries may be found in U.S. patent application Ser. No. 13/560,212, filed 27 Jul. 2012, U.S. patent application Ser. No. 13/560,901, filed 27 Jul. 2012, U.S. patent application Ser. No. 13/723,861, filed 21 Dec. 2012, and U.S. patent application Ser. No. 13/870,113, filed 25 Apr. 2013, each of which is incorporated by reference.

In particular embodiments, a social-networking system 160 may provide search results to a querying user based on user interactions with objects on an online social network. The social-networking system 160 may receive a search query and use a normalization component to generate one or more normalized queries based on the search query. In order to provide relevant search results, the social networking system 160 may record user interactions with objects on the online social network. User interactions, such as clicks, views, likes, and comments, may provide more nuanced insight into user preferences for particular search results. The social-networking system 160 may maintain a plurality of real-time counters and batch counters of the user interactions. Each counter may store a number of the type of user interactions the social-networking system has recorded. The social-networking system 160 may identify objects on the online social network that match the received search query. The social-networking system 160 may calculate an engagement score for each of the identified objects. The engagement score may be a weighted combination of values from one or more real-time counters and one or more batch counters associated with the particular identified object. Real-time counters may be updated in as a particular user interaction occurs (i.e., in real-time). Ranking search results based on real-time counters may allow the social-networking system to provide more relevant search results based on constantly changing user activity. With a large number of users (e.g., more than 10⁹ daily active users) and larger number of interactions by users with objects on the online social network (e.g., more than 10¹⁰ interactions daily), the tracking of real-time interactions can be difficult to process. Real-time counters may only record user interactions for a relatively short amount of time (e.g., the past 24 hours) in order to stay relevant. In contrast, batch counters may record user interactions over a longer period of time (e.g., the past month), showing the development of historical trends. However, aggregated user interaction data over even just a few days may require the storage of a large amount of data. It may be difficult to make user interaction data available in a timeframe that would be useful to the searching user. By calculating an engagement score based on real-time and batch counters, the social-networking system 160 may provide search results to users incorporating items with a comparatively high level of recent user interaction and items with a comparatively high level of interactions historically. The search results may reflect historical trends and recent events. The social-networking system may provide search results also representing trends and relationships between identified objects, search queries, and user interactions by calculating an engagement score based on counters storing this information. Using normalized queries allows the social-networking system 160 to identify and provide search results based on related search queries. The social-networking system 160 may present to the user a search-results interface comprising a plurality of search results corresponding to a plurality of identified objects. The social-networking system 160 may record user interactions with the identified objects corresponding to the search results and update one or more real-time counters. The social-networking system 160 may periodically update one or more batch counters based on one or more real-time counters. The updated real-time counters and batch counter may be used to provide search results for subsequent search queries. Although this disclosure describes using real-time counters and batch counters in a particular manner, this disclosure contemplates using real-time counters and batch counters in any suitable manner.

In particular embodiments, the social-networking system 160 may provide search results to a user based on real-time counters or batch counters that indicate user interactions with objects during a particular window of time. After receiving a search query, the social-networking system 160 may identify objects matching the search query, normalize the search query, and access records of user interactions with the identified objects. The records may store data about user interactions with the identified objects (e.g., counts of the interactions) that resulted from search queries that normalize to the normalized query. The records may include counts collected and made available as user interactions occur (i.e., in “real-time”). The records may include counts updated over time and made available for a period of time after the user interactions occur. The social-networking system 160 may calculate an engagement score based in part on a weighted combination of a plurality of counters. The social-networking system 160 may present to the user search results corresponding to the identified objects with an engagement score above a threshold score. The social-networking system 160 may update one or more counters associated with one or more of the identified objects based on user interactions with corresponding search results. As used herein, a normalized query refers to a search query to which a technique or function has been applied that creates a representation of the search query. A plurality of search queries may be represented (i.e., “normalized”) by the same normalized query. Search queries that normalize to the same normalized query may be referred to as related search queries through the normalization. A normalized query may allow the social-networking system 160 to identify similarities and relationships among search queries as well as user behavior with respect to objects matching those search queries. A real-time counter stores and makes available information relating to a particular user interaction approximately synchronously with the occurrence of the user interaction (i.e., in “real-time”). A real-time counter may only store information for a relatively short period of time. A batch counter stores information relating to user behavior updated periodically (i.e., not in real-time). A batch counter may store information for a longer period of time than a real-time counter. The engagement score may be a calculated probability representing how likely the first user is to interact with a particular identified object based on the recent and historical behavior of the first user and one or more second users with respect to the particular identified object and one or more search queries. As an example and not by way of limitation, the social-networking system 160 may receive the search query “Manoj photos” from a client system 130 of a first user. A normalization component, such as a locality-sensitive hashing component, described in detail below, may generate the normalized query “10001” based on the search query. The social-networking system 160 may identify a plurality of objects matching the search query. The social-networking system 160 may calculate an engagement score for each of the plurality of objects based on a weighted combination of one or more real-time counters and one or more batch counters. The one or more real-time counters may indicate a number of clicks associated with one or more of the identified objects, respectively, as a result of search queries that normalize to “10001” over the previous hour. The one or more batch counters may indicate a number of likes associated with one or more of the identified objects, respectively, as a result of search queries that normalize to “10001” over the previous fourteen days. The social-networking system 160 may send to the client system 130 of the first user a search-results interface comprising a plurality of search results corresponding to a plurality of the identified objects, respectively, that have an engagement score above a threshold score. The first user may interact with one or more of the search results through the search-results interface. The social-networking system 160 may update one or more of the real-time counters associated with one or more of the identified objects based on the first user's interactions with the identified objects corresponding to the search results. The updated counters may impact the search results presented responsive to subsequent searches. Although this disclosure describes providing search results to a first user based on real-time counters or batch counters in a particular manner, this disclosure contemplates providing search results to a first user based on real-time counters or batch counters in any suitable manner.

In particular embodiments, the social-networking system 160 may receive a search query. The search query may be inputted at a client system 130 of a first user of an online social network. The search query may be received by the social-networking system 160 from the client system 130. In some embodiments, and as described above, the search query may be a text query, which is a text string comprising one or more characters of text inputted by the first user. In general, a user may input any character string into a search query field to search for content on the social-networking system 160 that matches the text query. The social-networking system 160 may log the search query to record that the search query has been received. As an example and not by way of limitation, social-networking system 160 may receive from a client system 130 a search query such as “Manoj photos”. As another example and not by way of limitation, the social-networking system 160 may receive a search query such as “Boston restaurants.” Although this disclosure describes receiving particular search queries in a particular manner, this disclosure contemplates receiving any suitable search queries in any suitable manner.

In particular embodiments, the social-networking system 160 may generate, by a normalization component, a normalized query based on the search query received from the client system 130. The social-networking system 160 may pass the received search query to a normalization component of the social-networking system 160. The normalization component may apply a specific technique or function to create a representation of the search query. The normalization component may be configured to use a technique or function that may generate the same normalized query for a plurality of distinct search queries. Such a plurality of search queries may be said to be related through this normalization. A normalized query may allow the social-networking system 160 to identify similarities among related search queries and the user behavior with respect to objects matching those queries. In particular embodiments, the normalization component may be configured to apply a variety of normalizations. In particular embodiments, the social-networking system 160 may use a plurality of normalization components, each normalization component configured to apply a single normalization. By generating a plurality of normalized queries, using a plurality of different normalization techniques, for a given search query, the normalization component may allow the social-networking system 160 to detect similarities between search queries related in different ways. The social-networking system 160 may log the normalized query in association with the search query as a way to record the technique or function used to generate the representation. In particular embodiments, the normalization component may comprise a locality-sensitive hashing component. Generating a normalized query may comprise applying, by the locality-sensitive hashing component, a hashing function to the search query that generates a hashed value representing the search query. The hashing function may normalize search queries by generating identical hashed values for search queries having greater than or equal to a threshold similarity and by generating non-identical hashed values for search queries having below the threshold similarity. Such a hashed value generated by the locality-sensitive hashing component may be the normalized query. As an example and not by way of limitation, the social-networking system 160 may pass the search query “Manoj photos” to a locality-sensitive hashing component. The locality-sensitive hashing component may apply a hashing function to the search query to generate the hashed value “10001” representing the search query. The hashed value “10001” may be used as the normalized query. The locality-sensitive hashing component may apply the same hashing function to the search query “Manoj photo” to generate the hashed value “10001.” Using this hashing function, the search queries “Manoj photo” and “Manoj photos” normalize to the same normalized query (i.e., “10001”) because the search queries “Manoj photo” and “Manoj photos” are above a threshold degree of similarity. The locality-sensitive hashing component may apply the same hashing function to the search query “Boston restaurants” to generate the normalized query “00111.” Using this hashing function, the search query “Boston restaurants” normalizes to a different normalized query than the search queries “Manoj photo” and “Manoj photos” because the search query “Boston restaurants” is below the threshold degree of similarity when compared to the search queries “Manoj photo” and “Manoj photos.” In particular embodiments, the normalization component may comprise an n-gram parsing component. Generating a normalized query may comprise parsing the search query and generating one or more n-grams based on the search query. As an example and not by way of limitation, the social-networking system 160 may pass the search query to an n-gram parsing component. The n-gram parsing component may parse the search query to identify one or more n-grams. Each of the n-grams generated by the n-gram generation component may be returned to the social-networking system 160 as a normalized query. The n-grams parsing component may only use, as a normalized query, n-grams above a threshold length to reduce the total number of normalized queries generated. This may reduce the number of real-time counters and batch counters that may be incorporated into the engagement score. The parsing may be performed as described in detail hereinabove. As an example and not by way of limitation, social-networking system 160 may pass the search query “Manoj photos London” to an n-gram parsing component. The n-gram parsing component may parse the search query and identify the n-grams “Manoj,” “photos,” “London,” “Manoj photos,” “Manoj London,” and “photos London.” The social-networking system 160 may use each n-gram as a normalized query. The n-gram parsing component may only return to the social-networking system 160 n-grams with more than two components as normalized queries. The n-gram parsing component may only return the n-grams “Manoj photos,” “Manoj London,” and “photos London,” as normalized queries. Although this disclosure describes generating particular normalized queries based on particular search queries in a particular manner, this disclosure contemplates generating any suitable normalized queries based on any suitable search queries in any suitable manner.

In particular embodiments, the social-networking system 160 may identify a plurality of objects matching the search query. In particular embodiments, identifying a plurality of objects matching the search query may comprise searching a plurality of data stores or verticals using the search query as described above. In particular embodiments an object may comprise a page of the online social network, a multi-media object, a post, a comment, an event, an advertisement, or any other suitable object stored on the online social network. Each object may be associated with a designated object-type. Each data store or vertical may correspond to a particular object-type. As an example, a vertical may correspond to photo-type objects. Another vertical may correspond to post-type objects. Searching each vertical may allow the social-networking system to search for objects of various object-types. In particular embodiments, the social-networking system 160 may access a social graph comprising a plurality of nodes and a plurality of edges connecting the nodes. Each of the edges between two of the nodes may represent a single degree of separation between them. The nodes may comprise a first node corresponding to the first user, and a plurality of second nodes corresponding to a plurality of objects, respectively. The plurality of identified objects matching the search query may correspond to a plurality of the second nodes, respectively. The social-networking system 160 may identify objects by searching for objects on the social graph up to a threshold degree of separation from the searching user. Although this disclosure describes identifying particular objects matching particular search queries in a particular manner, this disclosure contemplates identifying any suitable objects matching any suitable search queries in any suitable manner.

In particular embodiments, the social-networking system 160 may calculate, for each identified object, an engagement score representing a predicted engagement by the first user with the identified object. The engagement score may be based in part on one or more real-time counters associated with the identified object, one or more batch counters associated with the identified object, or any combination thereof. Each counter may comprise a key listing (1) the identified object, (2) the normalized query, and (3) a type of user interaction of a plurality of types of user interactions. Each counter may comprise a value corresponding to the key indicating a number of the respective type of user interaction with the identified object performed in response to search queries that normalize to the normalized query. The value for the one or more real-time counters may indicate user interactions during a first threshold window of time. The value for the one or more batch counters may indicate user interactions during a second threshold window of time longer than the first threshold window of time. For each identified object, the social-networking system 160 may calculate an engagement score representing a predicted engagement by the first user with the identified object. The predicted engagement for a particular identified object may represent a calculated likelihood of the first user interacting with the particular identified object. The engagement score may be used to determine identified objects to show to the user as search results because an identified object with a high degree of predicted engagement may be determined to be more relevant to the user. The user, therefore, may be more likely to interact with a search result corresponding to an identified object with a high degree of predicted engagement. The engagement score may be a weighted combination of a variety of signals provided by a variety of components of the social networking system 160. The signals may comprise a value provided by one or more real-time counters associated with the identified object. The signals may comprise a value provided by one or more batch counters associated with the identified object. The signals may comprise any other suitable signals for determining the relevancy or predicted engagement of an identified object. As an example, and not by way of limitation, an engagement score, E for a particular identified object o given a query q may be calculated according to the formula:

$$E ( o \vert q ) = R ( o \vert q ) + {\sum }_{i} W ( {u}_{i} ) {V}_{R} ( o , q , {u}_{i} ) + {\sum }_{j} W ( {u}_{j} ) {V}_{B} ( o , q , {u}_{j} )$$

where R (o|q) is a relevance of an object o given a query q, W(u) is a weighting factor based on a type of user interaction u, V_{R}(o,q,u) is a value of a real-time counter given an object o, a query q, and type of user interaction u, and V_{B}(o,q,u) is a value of a real-time counter given an object o, a query q, and type of user interaction u. Although this disclosure describes calculating a particular engagement score in a particular manner, this disclosure contemplates calculating any suitable engagement score in any suitable manner.

A real-time counter or batch counter may comprise a key:value pair. The key may be a searchable field indexed by the social-networking system 160, or a component thereof for searching the keys of a real-time counter store or batch counter store. The key may identify an identified object and other relevant information. In particular embodiments, the key may list (1) a particular identified object, (2) a normalized query, and (3) a type of user interaction of a plurality of user interactions. The key may identify a search query in place of a normalized query. Although this disclosure describes the methods herein with respect to a normalized query listed by the keys of the counters, the methods may be similarly performed with a search query listed by the keys of the counters. The identified object may be identified by a unique object identifier. The type of user interaction may be identified by an identifier representing the type of interaction. The value associated with the key, which also may be referred to as the value of the key or the value of the counter, may represent a number of user interactions of the respective type listed by the key that have been performed on the identified object as a result of search queries normalizing to the listed normalized query that have been recorded by the social-networking system 160. The value may be stored and updated in association with the key. The value may be generated on-demand by retrieving a number of recorded user interactions and producing a count of the records corresponding to the key. In particular embodiments, a user interaction may be an impression, a click, a view, a like, a share, a comment, or any other suitable user interaction. An impression may comprise when an identified object is provided to a user, even if the user does not otherwise interact with the identified object. A click may comprise a user selecting an identified object through a click by mouse input, a tap input, voice-controlled selection, or any other method of selection. A counter may include a click-through rate for an identified object. A click-through-rate may comprise a ratio of user click-type interactions with a particular object to user view-type interactions with the particular object. A view may comprise a user accessing an identified object for a threshold period of time. Identified objects of different object-types may be associated with different protocols for determining whether a user interaction is sufficient to be considered a view. For example, a view for a video-type object may require the user to play the video for a set length of time, or a percentage of the length of the video. A post-type object may require the user to have the post-type object open for a set length of time, or require the user to scroll to a chosen paragraph. A counter may record an amount of time a user spent viewing an identified object. As an example and not by way of limitation, key:value pair “id_35487|‘10001’|click:100” may represent that 100 click-type user interactions have been recorded with the identified object represented by the object identifier “id_35487” as a result of search queries that normalized to “10001.” As another example and not by way of limitation, key:value pair “id_35487|‘photos London’|impression:1000” may represent that 1000 impression-type user interactions have been recorded with the identified object represented by the object identifier “id_35487” as a result of search queries that normalized to “photos London.” The value associated with a real-time counter may represent user interactions recorded during a first threshold window of time. The first threshold window of time may coincide with the amount of time that the real-time counter stores a particular user interaction with an identified object. The first threshold window of time may indicate a window of time of relevance of user interactions. When a particular user interaction with an identified object is determined to have occurred after the threshold window of time, the value for the key listing the identified object, normalized query, and type of user interaction may be decreased. The record representing the particular instance of the user interaction may be removed from the logged user interactions. A real-time counter may record, and make available, data about a user interaction approximately synchronously with the occurrence of the user interaction. As an example, and not by way of limitation, a real-time counter may make a record of a user interaction available within seconds after the user interaction has occurred, and may store a count for each user interaction for three days after the user interaction occurs. The value associated with a batch counter may represent user interactions recorded beyond the first threshold window of time for a real-time counter. A batch counter may represent user interactions recorded during a second threshold window of time longer than the first threshold window of time for a real-time counter. As an example and not by way of limitation, a batch counter may take up to a day to make a record of a particular user interaction available and may store a count for each user interaction for thirty days after the user interaction occurs. In particular embodiments, the second threshold window of time for a batch counter may overlap with the first threshold window of time for a real-time counter. As an example, a real-time counter may store user interactions for the previous day and a batch counter may store user interactions for the previous fourteen days. In particular embodiments, the second threshold window of time for a batch counter may begin just after the end of the first threshold window of time for a real-time counter. As an example, a real-time counter may store user interactions for the previous seven days and a batch counter may store user interactions for the previous seven to sixty days. The update and storage time for a batch counter may be determined by the timing of updates to the batch counter. The value associated with a batch counter may be decreased in a manner similar to the value associated with a real-time counter. As an example and not by way of limitation, the social-networking system 160 may have received the search query “Manoj photos London” and generated the normalized queries “11001,” “Manoj photos,” and “photos London.” The social-networking system 160 may have identified a plurality of identified objects. The engagement score for the identified object corresponding to “id_35487” may comprise a weighted combination of the real-time counters and batch counters listed below.

| Type of Counter | Key | Value |
|---|---|---|
| Real-time | id_35487\|‘11001’\|click | 100 |
| Real-time | id_35487\|‘11001’\|impressions, | 25 |
| Real-time | id_35487\|‘Manoj photos’\|like | 10 |
| Real-time | id_35487\|‘photos London’\|share | 250 |
| Batch | id_35487\|‘11001’\|click | 1000 |
| Batch | id_35487\|‘photos London’\|impressions | 250 |

Although this disclosure describes calculating a particular engagement score based on particular real-time counters and particular batch counters in a particular manner, this disclosure contemplates calculating any suitable engagement score based on any suitable real-time counters and ay suitable batch counters in any suitable manner.

In particular embodiments, the key of a real-time counter or batch counter may further list (4) one or more of a user location, a platform identification, a time of the user interaction, or any other suitable user interaction information. As an example and not by way of limitation, a user location may comprise information regarding a current or past location of a first user. A user location may be determined automatically by the client system 130 of the first user such as by GPS or wireless triangulation services performed by the client system 130. The user location may correspond, for example, to a country, geographical sub-division, or city. The user location may be provided by the user, such as through a check-in feature provided by the online social network, or through the user's profile information. A platform identification may correspond to the type of the client system 130 of the first user, such as a mobile, tablet, or desktop device. The platform identification may correspond to whether the user is accessing the online social network using a browser or native application. The platform identification may correspond to the operating system of the client system 130 of the first user, such as a mobile or desktop operating system. A time of the user interaction may be determined by a time set by the client system 130 of the first user, or by a time set by the social-networking system 160 after recording the user interaction. As an example and not by way of limitation, a real-time counter may comprise the key:value pair “id_35487|‘11001’|impressions|‘London, England’:25” indicating that twenty five impression-type user interactions have been recorded for the object represented by “id_35487” from search queries that normalized to “11001” from users within the city of London, England. As another example and not by way of limitation, a batch counter may comprise the key:value pair “id_35487|‘photos London’|share|‘mobile’:250” indicating that two hundred fifty share-type user interactions have been recorded for the object represented by “id_35487” from search queries that normalized to ‘photos London’ from users accessing the online social network from a mobile-type device. The engagement score for the identified object corresponding to “id_35487” may comprise a weighted combination of the real-time counter and batch counter. Although this disclosure describes calculating a particular engagement score based on particular real-time counters and particular batch counters in a particular manner, this disclosure contemplates calculating any suitable engagement score based on any suitable real-time counters and ay suitable batch counters in any suitable manner.

In particular embodiments, the engagement score may be further based on one or more counter aggregators. Each counter aggregator may comprise a value combining the value of each counter of a plurality of counters based on a property associated with the identified object listed by the key of each counter of the plurality of counters. The social-networking system 160 may use other information indicating a link between interactions with objects besides the normalized query. This other information may include properties common to a plurality of objects. The common properties may include the author or owner of the object, the time the object was created, the type of the object, any other property of an object, or any combination thereof. A counter aggregator may combine the values of only real-time counters. A counter aggregator may combine the value of only batch counters. A counter aggregator may combine the values of both real-time counters and batch counters together. By aggregating the values of a plurality of counters based on a property associated with identified objects, the counter aggregator may allow the social-networking system 160 to identify user preferences for a particular type of object, or other property, when the user enters a search query that normalizes to a particular normalized query. The social-networking system 160 may use the value provided by one or more counter aggregators as an additional weighted component of an engagement score for a particular identified object. As an example, and not by way of limitation, the counter aggregator may aggregate the value of all real-time counters with a key listing a like-type interaction with a photo-type object based on the normalized query “10001.” The aggregated value may be used as an additional component of the engagement score as one measure representing the popularity, based on the frequency of likes, of photo-type objects in response to queries that normalize to “10001.” As another example, and not by way of limitation, the counter aggregator may aggregate the value of all real-time counters with a key listing any user interaction with the identified object “id_15487” and a normalized query “10001.” The aggregated value may be used as an additional component of the engagement score for the identified object as one measure representing the overall popularity, based on the frequency of interactions, of identified object “id_15487” in response to queries that normalize to “10001.” In particular embodiments, the counter aggregator may comprise an author-object aggregator. The value of the author-object aggregator may combine the value of each counter of a plurality of counters based on an author of the identified object listed by the key of each counter matching an author of the identified object listed by the key of each of the other counters of the plurality of counters. As an example and not by way of limitation, the social-networking system 160 may have identified a plurality of objects in response to a search query that normalized to “photos London.” For a particular identified object with author “BBC,” the author-object aggregator may combine the value of each real-time counter that lists an object with the author “BBC.” The counter aggregator value may be used as an additional component of the engagement score for the particular identified object indicating the popularity of identified objects with the same author as the particular identified object. In particular embodiments, the counter aggregator may comprise a recency-bucketing aggregator. The value of the recency-bucketing aggregator may combine the value of each counter of a plurality of counters based on an age of the identified object listed by the key of each counter being within the same one of a plurality of windows of time. The recency-bucketing aggregator may be configured to identify objects that have a time since creation (i.e, “age”) within one of a plurality of ranges of time elapsed (i.e., “window of time”). The identified objects within one of the plurality of windows of time may be referred to as within a particular “age bucket.” By comparing the popularity of objects within a plurality of age buckets, the recency-bucketing aggregator may allow the social-networking system 160 to determine that users searching for particular search queries have a preference for objects of a certain age. The recency-bucketing aggregator may, for example, allow the engagement score to include a determination of an identified object as breaking news. As an example, and not by way of limitation, the age buckets for a recency-bucketing aggregator may comprise: (1) less than or equal to fifteen minutes; (2) greater than fifteen minutes and less than or equal to thirty minutes; (3) greater than thirty minutes and less than or equal to one hour; (4) greater than one hour and less than or equal to six hours; (5) greater than six hours and less than or equal to twenty-four hours; and (6) greater than twenty-four hours. The social-networking system 160 may have identified a plurality of objects in response to the search query “Giants World Series.” While calculating the engagement score for a first identified object, a video-type object created five hours ago titled “Why the San Francisco Giants Will Win the World Series Tonight”, the recency-bucketing aggregator may combine the values of real-time counters of objects within the same age bucket as the first identified object, bucket (4) in this example. The value of the recency-bucketing aggregator may be weighted and included in the engagement score for the first identified object. While calculating the engagement score for a second identified object, a post-type object titled “Giants Win World Series!” created twenty minutes ago, the recency-bucketing aggregator may combine the values of real-time counters of objects within the same age bucket as the second identified object, bucket (2) in this example. Depending on current events (i.e., the San Francisco Giants having won the World Series twenty-five minutes ago) objects in bucket (2) may have more interactions than objects in bucket (4), causing the value of the recency-bucketing aggregator to be higher for the second identified object. This may cause the engagement score for the second identified object to be higher than the engagement score for the first identified object. Although this disclosure describes calculating a particular engagement score based on particular counter aggregators in a particular manner, this disclosure contemplates calculating any suitable engagement score based any suitable counter aggregators in any suitable manner.

In particular embodiments, the social-networking system 160 may send, to the client system 130 in response to the search query, a search-results interface comprising a plurality of search results corresponding to a plurality of the identified objects, respectively, having an engagement score greater than a threshold score. The social-networking system 160 may determine a plurality of the identified objects to send to the first user based on the engagement score of each of the plurality of identified objects. The social-networking system 160 may generate a plurality of search results with references to the plurality of identified objects, respectively, above a threshold engagement score. The social-networking system 160 may generate a search-results interface comprising the plurality of search results. The first user may be able to interact with the search-results interface and, in particular, with each of the search results, to interact with the identified object. In order to avoid the first user simply choosing the first search result presented without evaluating the other search results, thus skewing the rate of user interactions, which may be referred to as a “positional bias,” the social-networking system 160 may randomize the order of the search results corresponding to the identified objects with an engagement score above a threshold engagement score. In particular embodiments, the social-networking system 160 may compare a number of the plurality of search results corresponding to objects above the threshold engagement score to a threshold number of search results. If the number of search results is below the threshold number, the social-networking system 160 may temporarily lower the threshold engagement score and generate a new plurality of search results. In particular embodiments, the social networking system may rank each of the plurality of identified objects based on the engagement score of each identified object. The social networking system may generate search results for identified objects ranked above a threshold rank. The social networking system 160 may generate and send to the client system 130 of the first user a search-results interface comprising the search results for identified objects above a threshold rank. The search-results interface may present the results in rank order. The social-networking system 160 may present the search results in rank order based on the engagement score of each identified object in order to provide the results corresponding to the identified objects with the highest predicted engagement to the first user in the most prominent position. Although this disclosure describes sending a particular search-results interface to a particular client system 130 of the first user in a particular manner, this disclosure contemplates sending any suitable search-results interface to any suitable client system 130 of the first user in any suitable manner.

In particular embodiments, the social-networking system 160 may update one or more of the real-time counters associated with one or more of the identified objects corresponding to the search results based on user interactions by the first user with the plurality of search results. After the client system 130 of the first user receives the search-results interface, the user may be able to interact with the search-results interface and, in particular, with one or more of the search results. The user may interact with the identified object corresponding to the search result. The user may interact with the identified object in various ways, including one or more of the user interactions described above. The social-networking system 160 may record the particular user interaction in a log of user interactions. The social-networking system 160 may update one or more real-time counters based on the user interaction, the identified object, and the normalized query. The social-networking system 160 may look up the key corresponding to the identified object, normalized query, and type of user interaction. If a real-time counter with the key is found to exist, the value associated with that key may be incremented. If no real-time counter with the key is found to exist, a new real-time counter with that key may be created and set to an appropriate initialization value (i.e., one). As an example and not by way of limitation, the social-networking system 160 may present to the user a search-results interface comprising search results corresponding to one or more identified objects. The first user may interact with the search result corresponding to “id_35487” with a like-type user interaction. The social-networking system 160 may look up the real-time counters with the key “id_35487|11001|like” and “id_35487|‘Manoj photos’|like”. The social-networking system 160 may find a real-time counter with the key “id_35487|11001|like” and increment the value associated with the key. The social-networking system 160 may not find real-time counter with the key “id_35487|‘Manoj photos’|like” and create the real-time counter with a value of one (1). In particular embodiments, the social-networking system 160 may update one or more batch counters based on one or more real-time counters. The social-networking system may update one or more batch counters by identifying one or more batch counters with a corresponding real-time counter, the key of each identified batch counter may match the key of the corresponding real-time counter. The social-networking system 160 may adjust the value of each identified batch counter based on the value of the corresponding real-time counter. The social-networking system may reset the value of the real-time counter to an initialization value after the real-time counter is used to update the value of a corresponding batch counter. Because a batch counter does not make user interaction data available in real-time, one or more batch counters may be updated on a periodic basis. The batch counters may be updated using real-time counters because the real-time counters have accurate values for the counts based on the activity recorded until the time for updating the batch counters. The social-networking system 160 may update a batch counter by determining a time since the batch counter was last updated. The social networking system 160 may determine a number of user interactions that have been added to a corresponding real-time counter in the time since the batch counter was last updated. In particular embodiments, the respective threshold windows of time for a real-time counter and a batch counter may not overlap. After a batch counter is updated based on a corresponding real-time counter, the real-time counter may be reset to an appropriate initialization value (i.e., zero (0)). The real-time counter may be removed from the store of real-time counters. Each real-time counter may be used to update a batch counter with a corresponding key. If a batch counter does not exist corresponding to the key of a real-time counter, a new batch counter may be created with the value of the real-time counter. The social-networking system 160 may update the batch counters on a regular or periodic basis. The social-networking system 160 may update the batch counters during an off-peak or low-usage time in order to increase the availability of computing resources to assist in updating the batch counters while minimizing the impact on the online social network. Although this disclosure describes updating particular real-time counters in a particular manner, this disclosure contemplates updating any suitable real-time counters in any suitable manner.

In particular embodiments, the social-networking system 160 may update in real-time one or more real-time counters associated with one or more objects based on user interactions by one or more second users with the one or more objects. The social-networking system may record and log user interactions by one or more second users with one or more objects of the online social network. The social network may provide search results to the first user based on the user interactions of the second users. The second users may interact with the objects as a result of searching for the objects. In particular embodiments, the social-networking system 160 may provide an interface of the online social network allowing a second user to browse references to a plurality of objects. As a second user browses the interface, the second user may interact with one or more of the plurality of objects. When the second user interacts with the one or more objects, the social-networking system 160 may update one or more real-time counters associated with the object. As an example and not by way of limitation, the social-networking system 160 may record the user interaction and update the real-time counters associated with the object by looking up real-time counters with a key listing the object as the identified object and the type of interaction of the second user. The social-networking system 160 may use a placeholder for the normalized query, allowing the social-networking system 160 to increase the value associated with each real-time counter listing the object and type of interaction. As an example, the second user may interact with the object “id_12648” with a share-type interaction. The social-networking system 160 may look up the key “id_12648|*|share,” where * indicates a placeholder or wildcard for the normalized query. The social-networking system 160 may increase the value of all keys matching the placeholder key. Updating the real-time counters in this way reflects an overall increased sharing rate for the object. As another example, and not by way of limitation, the social-networking system 160 may update the real-time counters associated with the object by using the object and type of interaction from the browsing user's interaction, and generate a search query to use to generate normalized queries. The social-networking system 160 may generate a search query based on one or more of the second user's previous search queries, one or more properties of the object, social-networking information of the second user, any other information relevant to generating search queries, or any combination thereof. The one or more object properties may include the author of the object, the owner of the object, the type of object, technical information associated with the object, the object's connection to the second user, any other suitable properties, or any combination thereof. The social-networking information known about the second user may include social-graph affinity to the object or author of the object, degree of separation from the object, any other social-networking information, or any combination thereof. As an example, the second user may interact with the object “id_12648” with a share-type interaction while browsing the newsfeed interface of the online social network. The social-networking system 160 may determine that the object is a photo created by the user “Manoj” and generate the search query “Manoj photo” from which to generate normalized queries by passing to a normalization component. The normalization component may generate the normalized query “10001.” The social-networking system 160 may update the value for the real-time counter with the key “id_12648|10001|share.” Updating the real-time counters in this way allows the social-networking system 160 to only update normalized queries predicted to be relevant to the browsing, and later searching, activities of users. Although this disclosure describes updating particular real-time counters in a particular manner, this disclosure contemplates updating any suitable real-time counters in any suitable manner.

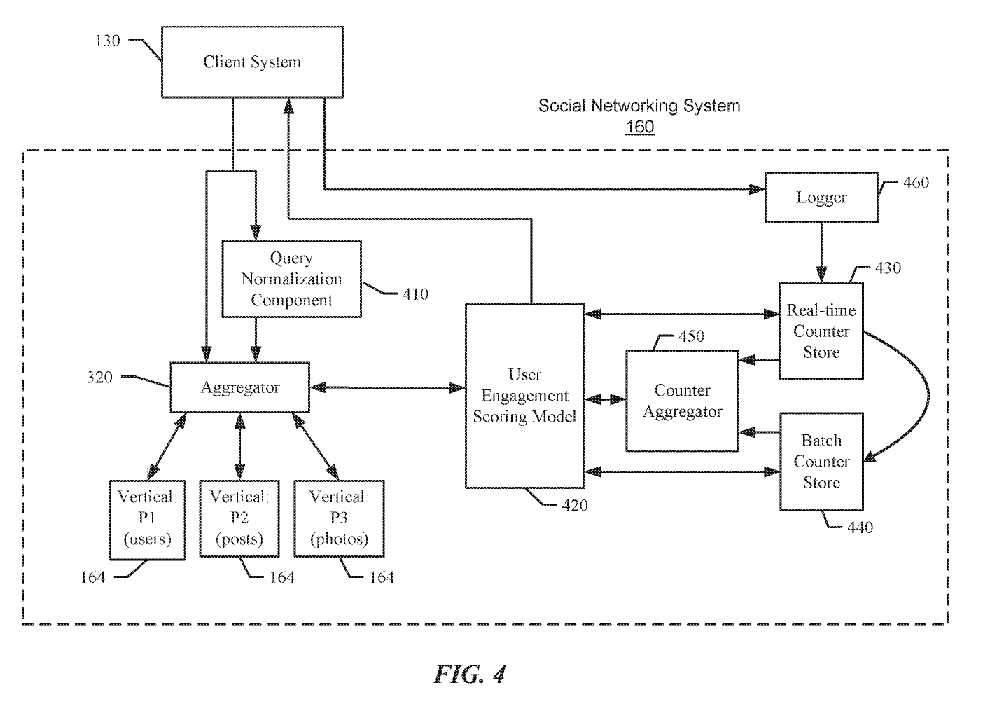

FIG. 4 illustrates an example configuration of social-networking system 160 supporting real-time counters and batch counters. The lines of FIG. 4 indicate the possible flow of data throughout the system. A client system 130 sends a search query to the social-networking system 160. The social-networking system 160 may route the search query to an aggregator 320 and a query normalization component 410. The query normalization component 410 may generate one or more normalized queries based on the search query. The query normalization component 410 may send the normalized queries to the aggregator 320. The aggregator 320 may search one or more verticals 164 for one or more objects matching the search query. In the system of FIG. 4, the aggregator 320 searches Vertical P1 corresponding to users, Vertical P2 corresponding to posts, and Vertical P3 corresponding to photos. The verticals 164 corresponding to posts and photos may identify a plurality of objects matching the search query. The aggregator 320 may send the plurality of objects, the search query, and the normalized query to the user engagement scoring model 420. In the example system of FIG. 4, the user engagement scoring model 420 is responsible for calculating the user engagement score. The user engagement scoring model 420 may send the identified objects, the search query, and the normalized query to the real-time counter store 430 and to the batch counter store 440. The real-time counter store 430 may send to the user engagement scoring model 420 the values of one or more real-time counters with keys matching the identified objects, the search query, and the normalized query. The batch counter store 440 may send to the user engagement scoring model 420 the values of one or more batch counters with keys matching the identified objects, the search query, and the normalized query. In particular embodiments, the user engagement scoring model 420 may determine the user interaction types to list in the key of each counter retrieved. In particular embodiments, the real-time counter store 430 may determine the user interaction types to list in the key of each real-time counter retrieved and the batch counter store 440 may determine the user interaction types to list in the key of each batch counter retrieved. The user engagement scoring model 420 may send the one or more identified objects, the search query, and the normalized query to the counter aggregator 450. The counter aggregator 450 may retrieve from the real-time counter store 430 and the batch counter store 440 the value of one or more counters. The counter aggregator 450 may combine the respective values of a plurality of counters based on a common property associated with the identified object listed by the plurality of counters. The counter aggregator 450 may send one or more combined values to the user engagement scoring model 420. The user engagement scoring model 420 may calculate a user engagement score for each of the plurality of identified objects based on the retrieved values from the real-time counter store 430, the batch counter store 440, and the counter aggregator 450. The social-networking system 160 may send to the client system 130 a search-results interface comprising a plurality of search results corresponding to a plurality of identified objects, respectively, having an engagement score greater than a threshold score as determined by the user engagement scoring model 420. The user may interact with one or more of the search results and corresponding identified objects. In response to the user interactions, the client system 130 may send to the social-networking system 160 records of the one or more user interactions. The social-networking system 160 may direct the records of the user interactions to a logger 460. The logger 460 may store the records of user interactions for a window of time. The logger 460 may send the records of the user interactions to the real-time counter store 430, which may update corresponding real-time counters. Periodically, the real-time counter store 430 may send real-time counters to the batch counter store 440. The batch counter store 440 may update corresponding batch counters corresponding to the real-time counters. The updated real-time counters in the real-time counter store 430 and updated batch counters in the batch counter store 440 may be used to provide updated search results for the next received search query. Although the disclosure describes and illustrates particular components, devices, or systems carrying out particular steps of providing search results based on real-time counters and batch counters, this disclosure contemplates any suitable combination of any suitable components, devices, or systems carrying out any suitable steps of providing search results based on real-time counters and batch counters in any suitable manner or order, including any suitable steps, which may include all, some, or none of the steps of FIG. 4.

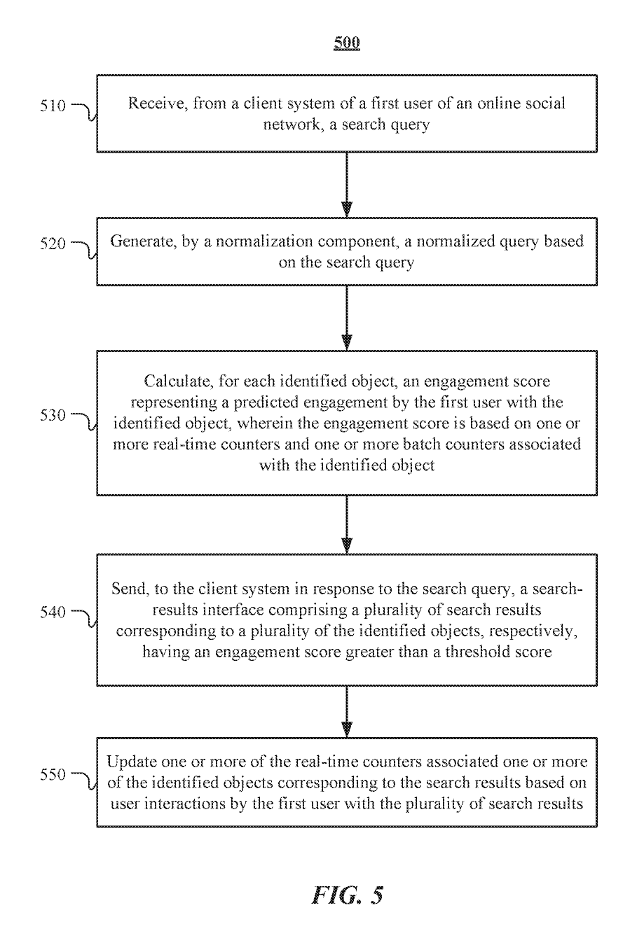

FIG. 5 illustrates an example method 500 for providing search results to a first user based on real-time counters or batch counters that indicate user interactions with objects. The method may begin at step 510, where the social-networking system 160 may receive, from a client system 130 of a first user of an online social network, a search query. At step 520, the social-networking system 160 may generate, by a normalization component, a normalized query based on the search query. At step 530, the social-networking system 160 may calculate, for each identified object, an engagement score representing a predicted engagement by the first user with the identified object, wherein the engagement score is based on one or more real-time counters and one or more batch counters associated with the identified object. At step 540, the social-networking system 160 may send, to the client system 130 in response to the search query, a search-results interface comprising a plurality of search results corresponding to a plurality of the identified objects, respectively, having an engagement score greater than a threshold score. At step 550, the social-networking system 160 may update one or more of the real-time counters associated one or more of the identified objects corresponding to the search results based on user interactions by the first user with the plurality of search results. Particular embodiments may repeat one or more steps of the method of FIG. 5, where appropriate. Although this disclosure describes and illustrates particular steps of the method of FIG. 5 as occurring in a particular order, this disclosure contemplates any suitable steps of the method of FIG. 5 occurring in any suitable order. Moreover, although this disclosure describes and illustrates an example method for providing search results to a first user based on real-time counters or batch counters that indicate user interactions with objects including the particular steps of the method of FIG. 5, this disclosure contemplates any suitable method for providing search results to a first user based on real-time counters or batch counters that indicate user interactions with objects including any suitable steps, which may include all, some, or none of the steps of the method of FIG. 5, where appropriate. Furthermore, although this disclosure describes and illustrates particular components, devices, or systems carrying out particular steps of the method of FIG. 5, this disclosure contemplates any suitable combination of any suitable components, devices, or systems carrying out any suitable steps of the method of FIG. 5.

In particular embodiments, the social-networking system 160 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 170 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, the social-networking system 160 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile interfaces, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, the social-networking system 160 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 160 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, the social-networking system 160 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, the social-networking system 160 may calculate a coefficient based on a user's actions. The social-networking system 160 may monitor such actions on the online social network, on a third-party system 170, on other suitable systems, or any combination thereof. Any suitable type of user actions may be tracked or monitored. Typical user actions include viewing profile interfaces, creating or posting content, interacting with content, tagging or being tagged in images, joining groups, listing and confirming attendance at events, checking-in at locations, liking particular interfaces, creating interfaces, and performing other tasks that facilitate social action. In particular embodiments, the social-networking system 160 may calculate a coefficient based on the user's actions with particular types of content. The content may be associated with the online social network, a third-party system 170, or another suitable system. The content may include users, profile interfaces, posts, news stories, headlines, instant messages, chat room conversations, emails, advertisements, pictures, video, music, other suitable objects, or any combination thereof. The social-networking system 160 may analyze a user's actions to determine whether one or more of the actions indicate an affinity for subject matter, content, other users, and so forth. As an example and not by way of limitation, if a user frequently posts content related to “coffee” or variants thereof, the social-networking system 160 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile interface for the second user.

In particular embodiments, the social-networking system 160 may calculate a coefficient based on the type of relationship between particular objects. Referencing the social graph 200, the social-networking system 160 may analyze the number and/or type of edges 206 connecting particular user nodes 202 and concept nodes 204 when calculating a coefficient. As an example and not by way of limitation, user nodes 202 that are connected by a spouse-type edge (representing that the two users are married) may be assigned a higher coefficient than a user nodes 202 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in a first photo, but merely likes a second photo, the social-networking system 160 may determine that the user has a higher coefficient with respect to the first photo than the second photo because having a tagged-in-type relationship with content may be assigned a higher weight and/or rating than having a like-type relationship with content. In particular embodiments, the social-networking system 160 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, the social-networking system 160 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 200. As an example and not by way of limitation, social-graph entities that are closer in the social graph 200 (i.e., fewer degrees of separation) may have a higher coefficient than entities that are further apart in the social graph 200.

In particular embodiments, the social-networking system 160 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 130 of the user). A first user may be more interested in other users or concepts that are closer to the first user. As an example and not by way of limitation, if a user is one mile from an airport and two miles from a gas station, the social-networking system 160 may determine that the user has a higher coefficient for the airport than the gas station based on the proximity of the airport to the user.

In particular embodiments, the social-networking system 160 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, the social-networking system 160 may provide information that is relevant to user's interests and current circumstances, increasing the likelihood that they will find such information of interest. In particular embodiments, the social-networking system 160 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, the social-networking system 160 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results interface than results corresponding to objects having lower coefficients.

In particular embodiments, the social-networking system 160 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 170 (e.g., via an API or other communication channel), or from another suitable system. In response to the request, the social-networking system 160 may calculate the coefficient (or access the coefficient information if it has previously been calculated and stored). In particular embodiments, the social-networking system 160 may measure an affinity with respect to a particular process. Different processes (both internal and external to the online social network) may request a coefficient for a particular object or set of objects. The social-networking system 160 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

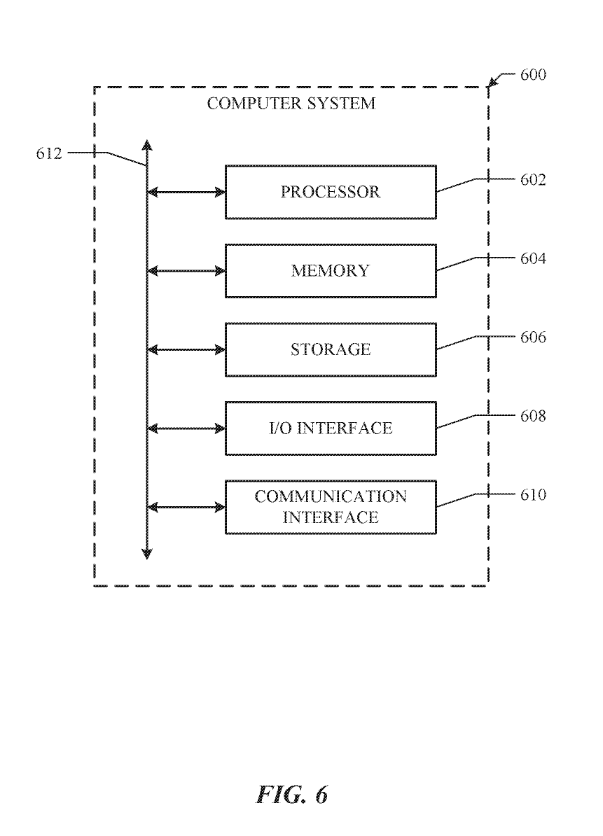

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

[79] In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing machines:
receiving, from a client system of a first user of an online social network, a search query;
generating, by a normalization component, a normalized query based on the search query;
identifying a plurality of objects matching the search query;
calculating, for each identified object, an engagement score representing a predicted engagement by the first user with the identified object, wherein the engagement score is based on one or more real-time counters and one or more batch counters associated with the identified object, wherein each counter comprises:
a key listing (1) the identified object, (2) the normalized query; and (3) a type of user interaction of a plurality of types of user interactions, and
a value corresponding to the key indicating a number of the respective type of user interaction with the identified object performed in response to search queries that normalize to the normalized query, wherein the value for the one or more real-time counters indicates user interactions during a first threshold window of time, and wherein the value for the one or more batch counters indicates user interactions during a second window of time longer than the first threshold window of time;
sending, to the client system in response to the search query, instructions for presenting a search-results interface comprising a plurality of search results corresponding to a plurality of the identified objects, respectively, having an engagement score greater than a threshold score; and
updating one or more of the real-time counters associated with one or more of the identified objects corresponding to the search results based on user interactions by the first user with the plurality of search results.

2. The method of claim 1, further comprising:
identifying one or more batch counters with a corresponding real-time counter, the key of each identified batch counter matching the key of the corresponding real-time counter;
adjusting the value of each identified batch counter based on the value of the corresponding real-time counter; and
resetting the value of the real-time counter to an initialization value.

3. The method of claim 1, wherein the key for each counter further lists (4) one or more of a user location, a platform identification, or a time of the user interaction.

4. The method of claim 1, further comprising:
accessing a social graph comprising a plurality of nodes and a plurality of edges connecting the nodes, each of the edges between two of the nodes representing a single degree of separation between them, the nodes comprising:
a first node corresponding to the first user; and
a plurality of second nodes corresponding to a plurality of objects, respectively;
wherein the plurality of identified objects matching the search query correspond to a plurality of the second nodes, respectively.

5. The method of claim 1, wherein the normalization component comprises a locality-sensitive hashing component, and wherein generating the normalized query comprises:
applying, by the locality-sensitive hashing component, a hashing function to the search query that generates a hashed value representing the search query, wherein the hashing function normalizes search queries by generating identical hashed values for search queries having greater than or equal to a threshold similarity and by generating non-identical hashed values for search queries having below the threshold similarity.

6. The method of claim 1, wherein the normalization component comprises an n-gram parsing component, and wherein generating the normalized query comprises:
parsing the search query and generating one or more n-grams based on the parsed search query.

7. The method of claim 1, wherein the engagement score is further based on one or more counter aggregators, wherein each counter aggregator comprises a value combining the value of each counter of a plurality of counters based on a property associated with the identified object listed by the key of each counter of the plurality of counters.

8. The method of claim 7, wherein the counter aggregator comprises an author-object aggregator, and wherein the value of the author-object aggregator combines the value of each counter of the plurality of counters based on an author of the identified object listed by the key of each counter matching an author of the identified object listed by the key of each of the other counters of the plurality of counters.

9. The method of claim 7, wherein the counter aggregator comprises a recency-bucketing aggregator, and wherein the value of the recency-bucketing aggregator combines the value of each counter of the plurality of counters based on an age of the identified object listed by the key of each counter being within the same one of a plurality of windows of time.

10. The method of claim 1, further comprising updating in real-time one or more real-time counters associated with one or more objects based on user interactions by one or more second users with the one or more objects.

11. The method of claim 1, wherein an object comprises:
a page of the online social network;
a multi-media object;
a post;
a comment;
an event; or
an advertisement.

12. The method of claim 1, wherein a user interaction comprises:
an impression;
a click;
a view;
a like;
a share; or
a comment.

13. One or more computer-readable non-transitory storage media embodying software that is operable when executed to:
receive, from a client system of a first user of an online social network, a search query;
generate, by a normalization component, a normalized query based on the search query;
identify a plurality of objects matching the search query;
calculate, for each identified object, an engagement score representing a predicted engagement by the first user with the identified object, wherein the engagement score is based on one or more real-time counters and one or more batch counters associated with the identified object, wherein each counter comprises:
a key listing (1) the identified object, (2) the normalized query; and (3) a type of user interaction of a plurality of types of user interactions, and
a value corresponding to the key indicating a number of the respective type of user interaction with the identified object performed in response to search queries that normalize to the normalized query, wherein the value for the one or more real-time counters indicates user interactions during a first threshold window of time, and wherein the value for the one or more batch counters indicates user interactions during a second window of time longer than the first threshold window of time;
send, to the client system in response to the search query, instructions for presenting a search-results interface comprising a plurality of search results corresponding to a plurality of the identified objects, respectively, having an engagement score greater than a threshold score; and
update one or more of the real-time counters associated with one or more of the identified objects corresponding to the search results based on user interactions by the first user with the plurality of search results.

14. A system comprising: one or more processors; and a non-transitory memory coupled to the processors comprising instructions executable by the processors, the processors operable when executing the instructions to:
receive, from a client system of a first user of an online social network, a search query;
generate, by a normalization component, a normalized query based on the search query;
identify a plurality of objects matching the search query;
calculate, for each identified object, an engagement score representing a predicted engagement by the first user with the identified object, wherein the engagement score is based on one or more real-time counters and one or more batch counters associated with the identified object, wherein each counter comprises:
a key listing (1) the identified object, (2) the normalized query; and (3) a type of user interaction of a plurality of types of user interactions, and
a value corresponding to the key indicating a number of the respective type of user interaction with the identified object performed in response to search queries that normalize to the normalized query, wherein the value for the one or more real-time counters indicates user interactions during a first threshold window of time, and wherein the value for the one or more batch counters indicates user interactions during a second window of time longer than the first threshold window of time;
send, to the client system in response to the search query, instructions for presenting a search-results interface comprising a plurality of search results corresponding to a plurality of the identified objects, respectively, having an engagement score greater than a threshold score; and
update one or more of the real-time counters associated with one or more of the identified objects corresponding to the search results based on user interactions by the first user with the plurality of search results.
